(19) United States
(12) Patent Application Publication
(10) Pub. No.: US 2025/0319736 A1
(43) Pub. Date: Oct. 16, 2025

(54) VEHICLE HVAC SYSTEM FOR USING PASSENGER COMPARTMENT HEAT FOR OPERATION

(71) Applicant: MAHLE INTERNATIONAL GMBH, Stuttgart (DE)

(72) Inventors: Edward WOLFE, IV, Clarence Ctr, NY (US); Kerstin WOCHELE, Friolzheim (DE); Bailey REID, Lockport, NY (US)

(21) Appl. No.: 18/887,749

(22) Filed: Sep. 17, 2024

Related U.S. Application Data
(60) Provisional application No. 63/632,113, filed on Apr. 10, 2024.

(51) Int. Cl. B60H 1/00

(52) U.S. Cl. CPC B60H 1/00021; B60H 1/00335; B60H 1/00899; B60H 2001/00114

(57) ABSTRACT

An HVAC system for a vehicle is provided, that includes a system to use passenger compartment heat for heating air within an HVAC system. The system includes a first air inlet configured, when installed within a vehicle, to receive air that flows therein from outside of the vehicle, and a second air inlet different from the first air inlet, the second air inlet configured, when installed within the vehicle, to receive air that flows therein from within a passenger compartment of the vehicle. A heat exchanger disposed to receive air from the first air inlet and the second air inlet via different flow paths simultaneously across different portions of the heat exchanger, and in some embodiments in substantially opposite directions.

### CROSS-REFERENCE TO RELATED APPLICATIONS

This application claims priority from U.S. Provisional Patent Application No. 63/632,113, filed on Apr. 10, 2024, the entirety of which is hereby incorporated by reference herein.

### BACKGROUND OF THE INVENTION

This application is directed to HVAC systems for vehicles, such as passenger vehicles that are always operated with electricity for propulsion and other loads, or for hybrid vehicles that are capable of being operated with electricity for propulsion and other loads. Auxiliary loads require the use of current from the vehicles battery in electric mode and therefore the use of auxiliary loads limits the range of the vehicle. This disclosure relates to improvements within the vehicle to limit the current draw from the battery for various auxiliary loads to improve the range of electric vehicles or hybrid vehicles being operated in electric mode.

### SUMMARY OF THE INVENTION

A representative embodiment of the disclosure is provided. The representative embodiment includes an HVAC system for a vehicle. The system includes a first air inlet configured, when installed within a vehicle, to receive air that flows therein from outside of the vehicle and a second air inlet different from the first air inlet, the second air inlet configured, when installed within the vehicle, to receive air that flows therein from within a passenger compartment of the vehicle. A heat exchanger is disposed to receive air from the first air inlet and the second air inlet via different flow paths simultaneously.

The heat exchanger may be an evaporator from an air conditioning system or a heat pump system.

The heat exchanger may be a cooler from a vehicle coolant system.

The representative embodiment of the paragraphs above may include the structure that is described in one or more of the Numbered Paragraphs 1-82 provided at the end of the specification of this application.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of an HVAC system that includes a system for providing recirculating passenger compartment air to heat intake air.

FIG. 2 is a side partial cross-sectional view of a portion of the HVAC system of FIG. 1.

FIG. 3 is a schematic view of a portion of the HVAC system of FIG. 1 wherein the heat exchanger (20) is aligned within a heat pump system to receive refrigerant within the heat pump system.

FIG. 4 is the view of the HVAC system of FIG. 3 aligned for natural circulation heating of the intake air (Z) with heat from the passenger compartment.

FIG. 5 is a schematic view of a portion of a different HVAC system of FIG. 1, wherein the heat exchanger (120) is aligned to receive coolant from an air conditioning system.

FIG. 6 is the view of the HVAC system of FIG. 5 aligned for local circulation of coolant for heating the air intake (Z) with heat from the passenger compartment.

FIG. 7 is a cross-sectional side view of an HVAC system of any one of FIGS. 1-6 that includes a modified second valve that is formed as a barrel valve, with the second valve in a first position to allow air flow from the heat exchanger to the relief system outlet.

FIG. 8 is the cross-sectional view of FIG. 7 showing the second valve in a second position that prevents air flow from the heat exchanger to the relief system outlet.

FIG. 9 is a cross-sectional perspective view that shows the second valve in the position of FIG. 8.

FIG. 10 is a perspective view of the second valve.

FIG. 11 is a side cross-sectional view of an alternate embodiment that can be used with one or more of the above embodiments where the outlet of the relief line (42/20/44) is connected with a venturi to establish a negative pressure at the outlet of the relief line when the vehicle that includes the HVAC system is moving in a forward direction.

FIG. 12 is the view of FIG. 11 depicting the outlet of the relief line positioned just rearward of the neck of the venturi.

### DETAILED DESCRIPTION OF THE INVENTION

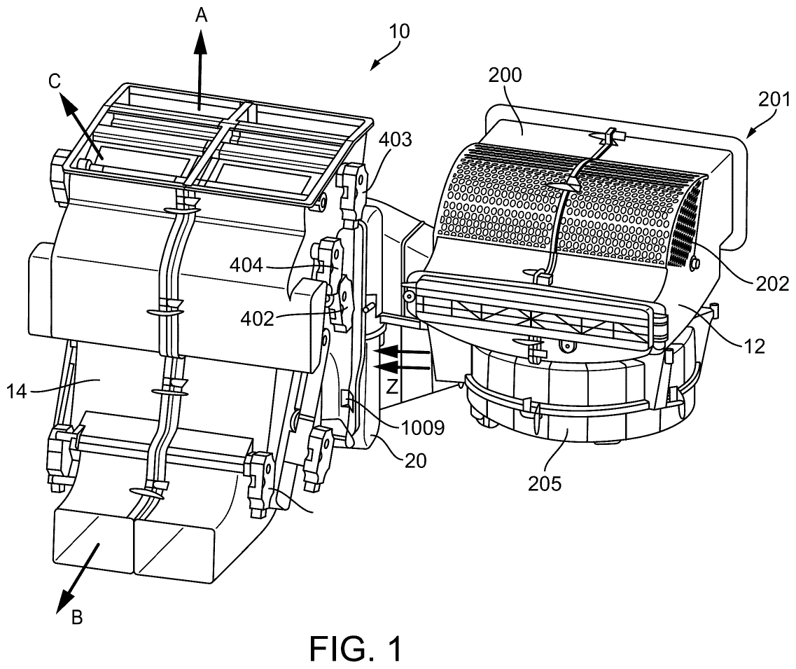

Turning now to FIGS. 1-6, a HVAC (heating, ventilation, and air conditioning) system 10, 100 is provided. The HVAC system 10, 100 is described herein as provided within a vehicle, such as a passenger vehicle, but the HVAC system can readily alternatively be provided for other types of vehicles or machines that include passenger or operator compartments with controlled air conditioning, heating, and the like, such as cranes, tractors, trains, aircraft, ships, as well as area spaces, and the like. For the sake of brevity, the HVAC system 10, 100 is only discussed for use in a passenger vehicle, but one of ordinary skill with a thorough review and understanding of this specification will readily appreciate that the HVAC system 10, 100 can also be used for other vehicles, machines, and spaces with conditioned air flow, with a modifications to the systems 10, 100 that would be appropriate for the different uses as discussed below.

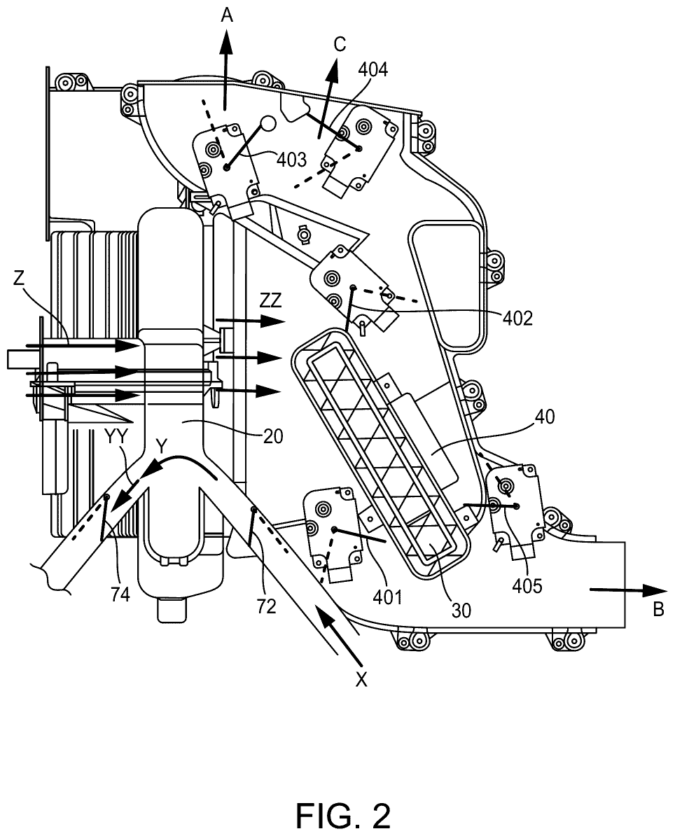

The HVAC system 10, 100 may be a portion of a fully HVAC system for a vehicle, and include air inlets from one or both of outside air 201 (i.e. air not from the passenger compartment), air from the passenger compartment 202 (also referred to as recirc. air herein), and is shown in FIGS. 1 and 2. The HVAC system receives the air inlet, typically via the discharge of a fan (within fan housing 205, FIG. 1) that receives the intake air, and send the air through a first heat exchanger (20, 120), with an air flow schematically depicted as Z in the figures. The air leaving the heat exchanger 20, 120 (schematically depicted as ZZ in the figures) may then travel through a second heat exchanger (30, 130, typically a heater) or it may bypass the second heat exchanger 30, 130. The air ZZ (whether it travels through or bypasses the second heat exchanger 30, 130) then may be sent to one of a plurality of outlets of the HVAC system based upon the position of a plurality of valves (e.g. 401, 402) as controlled by the HVAC controller. For example, the valves may be positioned such that the air is sent to the defrost outlet (A) to apply heated air to defrost the front windshield and potentially other windows in the vehicle. Alternatively, the air may be sent to the panel outlets (C), and/or it may be sent to the floor outlets (B). FIG. 2 depicts the plurality of valves 401, 402, 403 404, 405 with each valve in its two possible positions, one position with a solid line and the second position with a dashed line (the valves may also be an intermediate position to allow reduced air flow as can be well understood.

Air that is drawn into the HVAC may either be outside air, which enters the HVAC system through inlet 201 (FIG. 1) or it may be passenger compartment air (also called recirc. air) which enters the HVAC system through inlet 202. The HVAC controller 1009 (FIG. 1, schematic) may control the position of valves within the inlet housing 200 (valves not shown) that either allow recirc. and prevent outside air, allow outside air and prevent recirc. air, or are throttled to allow a combination of recirc. and outside air. The air that enters the housing 200 then flows through the fan (within housing 205) and flows to the heat exchanger 20/120 as discussed below. The housing 200 may be the same for both HVAC systems 10 and 100 discussed below.

The HVAC systems 10, 100 are provided to allow for heating the inlet air Z into the HVAC with heat that is already within the passenger compartment, to minimize the input of heat necessary (by the HVAC system, and specifically the HVAC heater 30, 130) to be added to the air that is used for the defrost cycle (flow A through the HVAC system-FIGS. 1 and 2). Specifically, air from outside the vehicle is typically used for defrost air (flow A) because the outside air includes a much lower relative humidity (and therefore due point) than the air within the passenger compartment (due to the presence of passengers within the passenger compartment who continuously give off moisture to air within the passenger compartment. In situations where the defrost is needed (i.e. when frost has or threatens to build up on the windshield or other windows, or fog collects on the windshield) the outside air is typically very cold and therefore need to be heated before reaching the windshield to remove the frost/fog from the windshield. With conventional HVAC systems, the air (Z, ZZ-FIGS. 1, 2) flows through heater 30 of the HVAC system that is either a coolant heat exchanger for systems with an engine or in systems with a heat pump the heating element is a heat pump heater (condensing function) that is part of the heat pump system, and the system may also include an electrical heater 40 (e.g. PTC heater or resistance heater) that is positioned in series with the heat pump heater and is operated by the HVAC controller if extra heat above the heat provided by the heat pump heater 30 is needed. The electrical power either is provided by current generated by the alternator in a vehicle with an internal combustion engine or for electric vehicles (either complete electric vehicles, or hybrid vehicles that are currently being powered by the battery) the electrical power is provided by the vehicle's battery. The use of the vehicle battery to power the heater 30, 130 limits the range of the vehicle.

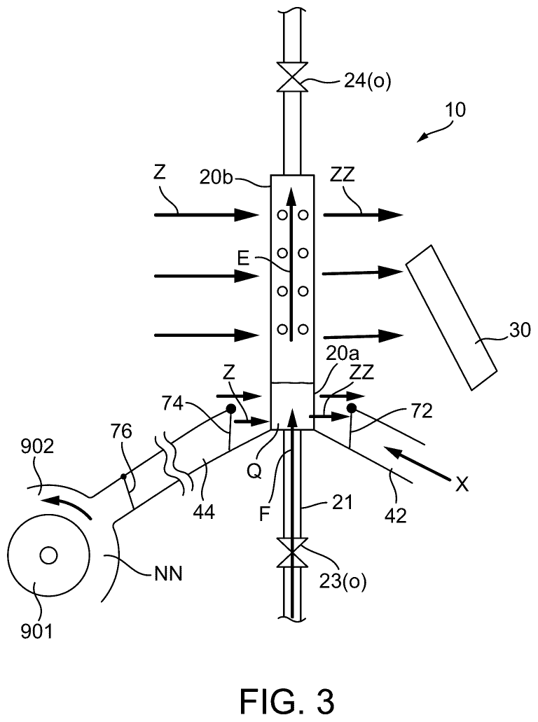

The heat exchanger 20, 120 that is provided within the HVAC system 10, 100 to solve the problems with current HVAC units in electrically powered vehicles (discussed above) is provided and is depicted in detail in FIGS. 3-6. Heat exchanger 20 is a heat exchanger that is associated with a heat pump system or an air conditioning system-both with circulating heat exchange fluid (i.e. refrigerant) heat exchange fluid as driven by a compressor or pump (not shown) where the heat exchanger 20 forms the evaporator of a typical heat pump/AC system, which during operation typically removes heat from the air that crosses past the evaporator (schematically air flow Z). The operation of a heat pump system (which also typically includes a compressor, expansion valve, and a condenser—each not shown) is well understood. The HVAC system 10 includes modifications to the heat exchanger 20 that allow the heat exchanger 20 to operate with natural circulation of the refrigerant (from the heat pump system) that is within the heat exchanger/evaporator 20, rather than with typical forced refrigerant circulation within the heat pump system (as urged by the compressor, and the thermodynamic changes with the refrigerant during normal operation of the heat pump system). Heat exchanger 120 is discussed separately below.

In some embodiments, the heat exchanger 20/120 may include a plurality of tubes to receive and enclose the refrigerant or coolant therein, and allow the refrigerant or coolant to flow therethrough (normal operations of the HVAC system) or to maintain the isolated refrigerant or coolant therein, i.e. the natural circulation embodiments discussed herein. The heat exchanger 20/120 may include a plurality of fins (or louvers) that either extend outward from one or more of the tubes and in some embodiments bridge multiple tubes. The air flow Z to the heat exchanger flows over the outside of the tubes and the plurality of fins to maximize the surfaces that the air flow contacts for maximum convection heat transfer. In some embodiments, some of the fins may be of open construction (i.e. to allow air to flow through the fin as well as across the surface of the fin) to generate turbulent air flow across the fins to further increase heat transfer. In some embodiments, some of the fins may be closed construction, with the fins with open and closed construction being positioned to allow for differing amounts of heat transfer at different locations along the length of the heat exchanger 20/120. In one embodiment, open fins may be provided at the locations of the heat exchanger where air flow Z from the fan is received, and also open fins may be provided at the lower portion of the heat exchanger where air flow X from the passenger compartment is received (both flow paths discussed in detail below) with some closed fins provided in a space between the positions where air flows Z and X will be received.

Heat exchanger 20 receives refrigerant therein (shown schematically as Q in FIG. 3) based upon its connection with the remainder of the heat pump system. A first line 21 is connected to the heat exchanger 20 at a lower portion 20a of the heat exchanger (as the HVAC system is installed within a vehicle or other machine with respect to the force of gravity) and a second line 22 is connected to the heat exchanger 20 at a high portion 20b that is vertically above the lower portion 20a. The first line 21 includes a first valve 23 that can be open (O) or shut(S) to allow refrigerant flow or prevent refrigerant flow therethrough, respectively. Similarly, the second line 22 includes a second valve 24 that can be open (O) or shut(S) to allow refrigerant flow or prevent refrigerant flow therethrough, respectively. The first valve 23 is at the refrigerant inlet of the heat exchanger 20. This valve may be a typical isolation valve that can be controlled by the HVAC controller to either an open or shut position. Alternatively, the valve 23 may be the TXV (thermostatic expansion valve) and not a conventional isolation valve. The TXV may be fixed in position. Alternatively, the valve 23 may be an EXV (electronic expansion valve) that is operated by the HVAC controller to alter its position. In some embodiments, when the compressor of the heat pump (or air conditioning) system is not operating, there is no refrigerant flow through the TXV or EXV so that the TXV/EXV operates as an isolation valve in the natural circulation operational state discussed herein. Alternatively, the construction of the heat exchanger 20 may be altered such that the first line 21 and first valve (which may be the TXV or an EXV) is positioned vertically above the heat exchanger, and the second line 22 and second valve 24 is below the heat exchanger. In still other embodiments, both valve 23 and the TXV- or EXV) may be provided in series with the valve 23 being controlled by the HVAC controller.

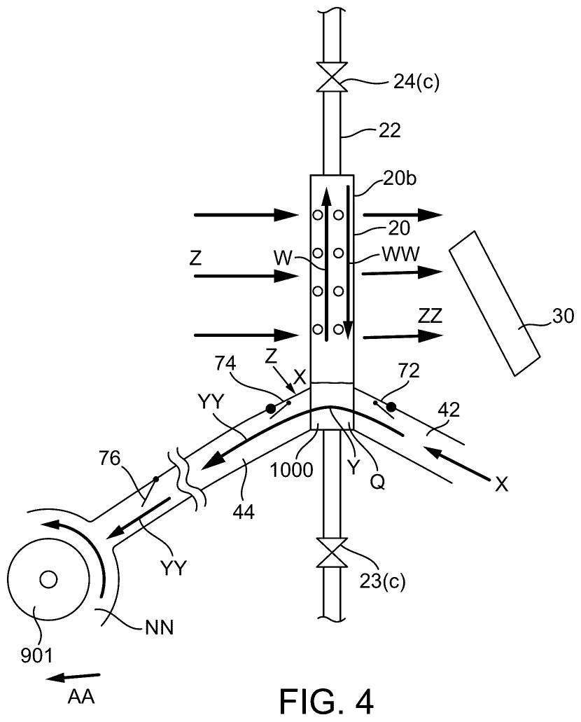

In embodiments where the TXV or EXV of a heat pump system are used for the valve 23, the position of the TXV or EXV may maintain constant (or as controlled by the HVAC controller for the EXV) in both the regular operations (FIG. 3) and the natural circulation operations (FIG. 4). In this embodiment, because during natural circulation operations the compressor (not shown) is not operating, no refrigerant flows through the TXV/EXV in this situation, so from the perspective of refrigerant within the system the valve (23) is “shut” (as depicted on FIG. 4)—i.e. refrigerant does not flow through the valve 23 (TXV, EXV) or only a di minimus amount of refrigerant flows through the valve 23 (TXV, EXV) which specifically is included within this definition of “does not flow through the valve” as used herein.

A relief air flow path 42, 44 is provided with respect to the heat exchanger 20. The term relief is used herein because this air flow path may be one of a plurality of relief flow paths to prevent overpressure within the passenger compartment and to minimize pressure transients within the passenger compartments, such as when open or closing doors or with deployment of one or more airbags. The passenger compartment may include additional relief flow paths in addition to the flow paths 42, 44, to continue to provide passenger compartment overpressure protection in situations where one or both of the inlet and outlet valves 72, 74, 76, 174 are shut, as discussed herein. In some embodiments, the flow path 42, 44 may not be designed to provide any overpressure protection and the passenger compartment may include other pressure relief flow paths. The term relief is used herein to describe the flow path 42, 44 for the sake of simplicity—but one of ordinary skill in the art with a thorough review and understanding of this specification will understand that it is within the scope of this specification to provide for the flow paths 42, 44 without passenger compartment overpressure protection being an intended (or actual, depending upon the positions of the valves) function. The term auxiliary air flow path may be used instead of relief to denote the flow paths 42, 44 and associated components and functionality of the system- and the use of term auxiliary air flow path does not result in a change of scope of the system described herein unless specifically noted below. The relief air flow path 42, 44 (or auxiliary flow path)—for the sake of brevity the term relief flow path will only be used below, but one or ordinary skill in the art will understand that the term auxiliary flow path could be replaced for relief flow path unless specifically noted below). The term recirculation as used in the priority application is referring to the relief system discussed herein. The relief air flow path 42, 44 may disposed to direct air flowing therethrough across the heat exchanger 20 at or proximate to the lower portion 20a of the heat exchanger 20. The relief air flow path 42, 44 is disposed vertically below the entirety or an significant majority of the location upon the heat exchanger where the air flow Z from the fan 205 flows across the heat exchanger 20. The term significant majority includes a percentage of flow greater than 50%, and in preferred embodiments between 70% to 100% including all values of flow within this range. In some embodiments, the relief air flow path 42, 44 is disposed below about 95% of the air flow Z from the fan 205, while in other embodiments, below about 90%, 85%, 80%, 75%, 70%, 65%, 60%, 55% and just above 50% of the air flow Z across the heat exchanger 20.

The relief air flow path includes an inlet portion 42 that directs air receive (X, schematic) toward and across the heat exchanger 20. The inlet portion 42 is configured to receive air X from the passenger compartment, i.e. recirc. air. The air X may be received from the passenger compartment via a different air source than the recirc. air 202 that flows into the air inlet housing 200 of the HVAC system, or it may be from the same air source as the recirc. air 202 that flows into the inlet housing 200, with the same air source having different flow path branches to provide the air to recirc. air inlet 202 and to the inlet portion 42.

The inlet portion 42 includes an inlet valve 72 that is controlled by the HVAC controller and includes a first position to completely or substantially prevent air flow X through the inlet portion 42 to the heat exchanger 20 (FIG. 3) or it may be in a second open position to allow air flow X through the inlet portion 42 to the heat exchanger 20 (FIG. 4). The term “substantially prevent” is defined herein to mean blocking the overwhelming majority of air flow X, but allowing some di minimus amount of flow past the valve-such as due to an imperfect connection between the valve seat at the walls of the portion 42 that provides some space for unintended air to flow therepast.

The air flow across the heat exchanger Z from the inlet housing 200 and fan 205, which is directed into the remainder of the HVAC and ultimately to the desired use (e.g. the defrost, A, cabin C, rear row B) flows past the heat exchanger 20 in a first direction (e.g. from left to right as FIGS. 3 and 4 are printed on the page) and the air flowing from the air inlet portion 42 across the heat exchanger 20 and to the air outlet portion 44 flows (X, Y) in the opposite direction (or substantially opposite direction), i.e. from the right to the left as FIGS. 3 and 4 are printed on the page). The term opposite directions means directions along lines that are parallel with each other, but extend in the opposite way along the line (e.g. one being right to left on the page, the other being left to right on the page). The term substantially opposite directions means two directions that are nearly parallel with each other, but may be different from being mathematically parallel with each other with a minor acute angle between the two lines forming the directions, such as 20 degrees or less. The minor acute angle may be a 2D angle (i.e. two vector components) although it may also be a 3D angle (i.e. with three differing vector components, but the differing vector components each differ with an angle of 20 degrees or less). In another embodiment, the air flow Z may flow through the heat exchanger 20 in the same or substantially the same direction as the flow from the air inlet portion 42, across the heat exchanger 20, and to the outlet portion 44 flows (X, Y). In this embodiment, FIGS. 3 and 4 would be redrawn with the inlet 42 appearing on the left side of the heat exchanger 20 (as drawn on the figure) and the air outlet 44 being on the right side of the heat exchanger, with flow Y moving from left to right across the heat exchanger 20. The term substantially the same means two directions that are nearly parallel with each other, but may be different from being mathematically parallel with each other with a minor acute angle between the two lines forming the directions, such as 20 degrees or less. The minor acute angle may be a 2D angle (i.e. two vector components) although it may also be a 3D angle (i.e. with three differing vector components, but the differing vector components each differ with an angle of 20 degrees or less). In yet another embodiment, the air inlet and outlet 42, 44 could be rearranged with respect to the heat exchanger such that the flow Y through the heat exchanger is in a direction into our out of the page of FIG. 4 (either exactly into or out of the page, or with a vector component that is into or out of the page).

The outlet portion 44 includes an outlet valve 74 that is controlled by the HVAC controller and includes a first position to completely or substantially prevent air flow YY from the heat exchanger 20 (FIG. 3) or it may be in a second open position to allow air flow YY from the heat exchanger 20 and through the outlet portion 44. The positions of the first and second valves 72, 74 are preferably controlled by the HVAC controller 1009 to be the same in all modes of operation of the HVAC system. In some embodiments, only one of the first or the second valves 72, 74 is provided, with the single valve (either within the inlet portion 42 or the 44) position either allowing or preventing air flow from the passenger compartment to flow through the inlet and outlet portions 42, 44.

The outlet portion 44 may extend between the heat exchanger 20 a position where the air that flows therethrough YY extends to an outlet 44b that is at a location at or proximate to with an unimpeded air flow path to outside of the vehicle. An exit valve 76 may be provided proximate to the outlet end 44b. In some embodiments, the exit valve 76 may be a check valve that allows flow YY in the direction of flow from the heat exchanger 20 to the outlet 44b, but substantially prevents flow in the reverse direction from the outlet 44b to the heat exchanger 20. In other embodiments, the exit valve 76 may be a remotely operable valve as operated by the HVAC controller (1009) and maintained in the same position as the outlet valve 74. In other embodiments, only the exit valve 76 may be provided (and the inlet and outlet valves 72, 74 are not provided). In this embodiment, the exit valve 76 may be a remotely controlled valve as controlled by the HVAC controller, with the position of the exit valve 76 either allowing or preventing the air flow from the passenger compartment through inlet and outlet lines 42, 44 and eventually out of the vehicle. In this embodiment, the exit valve 76 is a normally closed valve, and may be remotely opened when it is desired to have the relief air flow from the passenger compartment through the heat exchanger 20/120 and out of the vehicle.

In some embodiments, the outlet end 44b of the outlet portion 44 may be disposed at a position within the vehicle that has a negative pressure (vacuum), such as during operation of the vehicle. For example, at certain speeds of certain vehicles, a position (NN) within the vehicle's wheel well 902 proximate to the rear portion of the tire 901 (i.e. the portion of the tire 901 that faces (either directly or with a horizontal vector component) the rear of the vehicle, i.e. faces away from the direction of forward motion (arrow AA) of the vehicle (with the tire rotating as shown with the arrow in FIG. 3)) may be at a small negative pressure. The position of the outlet end 44b either at atmospheric pressure, or at a small negative pressure assists with flow through the inlet and outlet portions 42, 44 (flows X, Y, YY) and across the heat exchanger 20. In other embodiments, the outlet end 44b may be located at other locations within the vehicle than the wheel well where the air can flow through the outlet end 44b and to the outside with minimal air resistance (to avoid creating back pressure within the outlet portion 44). In some embodiments, one or both of the inlet or outlet portions 42, 44 may include a fan (not shown, but conventional) that urges flow through the inlet (direction X) or through the outlet (flow YY) each of which will urge flow Y through the heat exchanger 20. The fan may constantly operate, or may be operated by the HVAC controller to cause air flow Y when desired.

FIG. 4 is a schematic view of the HVAC system 10 that is aligned for natural circulation within the heat exchanger 20. The heat exchanger 20 is provided to remove heat from the recirc. air flow X through the inlet portion 42 as it passes the heat exchanger 20 (Y, and leaves the heat exchanger YY through the outlet portion 44) and provide the removed heat to the air Z that flows past the heat exchanger 20 from the air inlet housing 200. As depicted schematically in FIG. 4, recirc. air X flows past the heat exchanger 20 (Y) and specifically past a lower portion 20a of the heat exchanger 20 that includes liquid refrigerant (Q) or a combination of liquid refrigerant and refrigerant vapor, which is at a low pressure. In FIG. 4, valves 23 and 24 are closed so that there is no flow of refrigerant Q into our out of the heat exchanger 20. The air X, Y that flows across the bottom portion of the heat exchanger transfers heat from the air to the heat exchanger and specifically to the refrigerant Q proximate the air flow Y. This refrigerant (due to the low pressure within the heat exchanger 20) turns to vapor and therefore rises within the heat exchanger (arrow W) until it reaches a vertical position where it is aligned with the inlet air path Z (FIG. 4). The heat from the refrigerant is transferred to the lower temperature air flow Z, which increases the temperature of the air leaving the heat exchanger ZZ. This hotter air may directly flow to the defrost outlet (A) based upon the position of valves 402, 403 (FIG. 2) or it may be directed to flow through the heating element 30 in the event that more heat is needed to increase the temperature of the air ZZ to be usable for defrost purposes (A). In this case, the preheating of the air Z to ZZ within the heat exchanger decreases the amount of heat that needs to be provided by the heating element 30 (than if the system discussed herein was not provided or not operating), which reduces the current needed from the battery (or eliminates the current needed if the air ZZ is heated to the suitable temperature only by the heat exchanger 20.

As the heat from the refrigerant Q is transferred to the air Z to ZZ that flows past the heat exchanger 20, the refrigerant in some circumstances, or after giving off sufficient heat will condense into liquid form and fall to the lower portion 20a of the heat exchanger 20 (arrows WW), where the process continues with receiving heat from the recirc. air X, Y that flows past the lower portion 20a of the heat exchanger 20. This cycle continues as heat from the passenger compartment (via the recirc. air) is effectively transferred to the air flow Z from outside the vehicle (lower humidity than the recirc. air) to allow for the outside air to be used for the defrost cycle and for passenger compartment heating. This allows for heat to be provided at much less electrical current than would be necessary with convention operation of the HVAC system 10 with all of the heat input coming from the heater (due to heat pump system compressor operation to provide heat at the heater 30 and due to resistance heat from the secondary heater 40). In some embodiments, an air blower (not shown, conventional and upstream of valve 72) may be provided to urge recirc. air X to flow through the air inlet 42 and across the lower portion 20a of the heat exchanger and out the outlet 44 (in some embodiments as further aided by the negative pressure at the outlet 44b when the vehicle is moving in the forward direction.

After the need to use by the system in natural circulation mode is no longer needed (either automatically sensed by the HVAC controller, or with a passenger input) the HVAC controller (1009, schematic) reorients the operation of the HVAC system to operate as a typical heat pump system that provides a heat input to the air solely from the heat pump heater 30 and/or solely with the electrical heater 40 as needed. In either case, the HVAC controller 1009 may open valves 23 and 24 to allow refrigerant flow through the entire heat pump system, (with or without the compressor operation—as needed for the desired temperature of the air flow) and the HVAC controller changes the position of the various valves (401-405) as needed to generate the desired air flow(s) by the HVAC system.

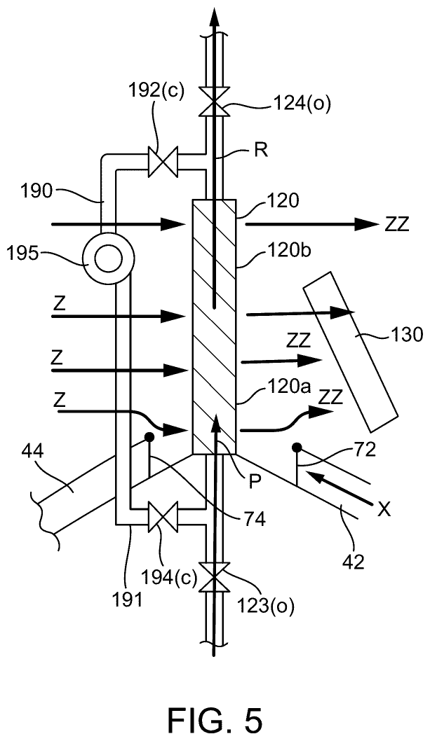

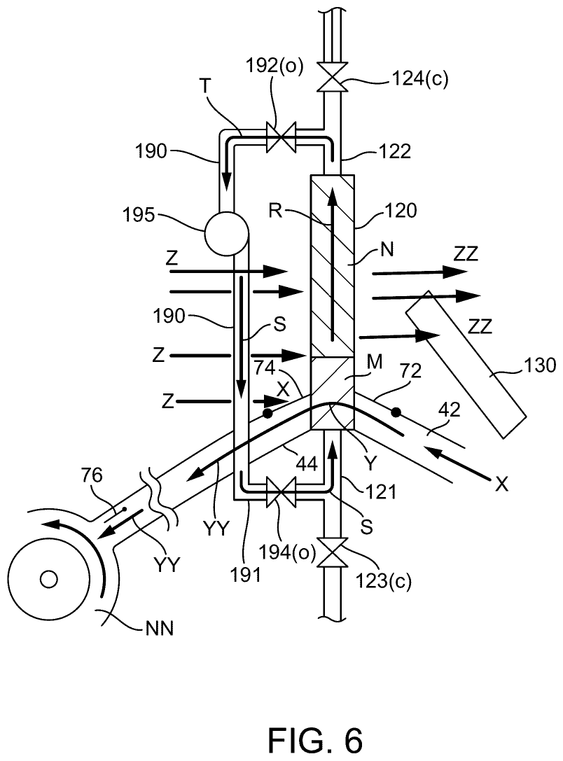

Turning now to FIGS. 5-6, the HVAC system 100 is similar to system 10, but used with an indirect system, such that the heat exchanger 120 is configured to receive heat exchange fluid that is vehicle coolant, rather than refrigerant. The vehicle coolant is cooled/heated as appropriate by a heat pump system (i.e. a chiller or a condenser as appropriate), but this heat transfer (i.e. the direct heat transfer) occurs outside of the HVAC system. In this embodiment, the heat exchanger 120 is a load on the HVAC system (e.g. the chiller) similar to other loads, e.g. the battery, brakes, etc. In some embodiments, the vehicle coolant that is provided to the heat exchanger 120 may selectively flow from the chiller (of a heat pump system) and/or it may flow from a radiator at the front end of the vehicle, with the cooling of the coolant provided by the convection heat transfer of the moving air past the radiator as the vehicle moves in the forward direction. A vehicle controller (or the HVAC controller 1009) may in this embodiment operate various isolation valves to control whether the coolant that reaches the heat exchanger 120 flows through the chiller of the heat pump system, the radiator, or both.

The system 100 includes inlet and outlet portions 42, 44 that receive air from the passenger compartment (X) and allows flow of the air past the heat exchanger 120 (flow Y) and flow leaving the heat exchanger (flow YY) to flow outside of the vehicle, as with the system 10. The inlet and outlet portions 42 and 44 of system 100 may be designed and operated by the HVAC controller 1009 in the inlet and outlet portions 42, 44 of the system 10 discussed above.

The heat exchanger 120 is provided within a coolant system. The heat exchanger includes a coolant inlet 121 and a coolant outlet 122, both of which include isolation valves 123, 124, respectively. The heat exchanger 120 additionally includes a bypass line 190/191 that extends from the coolant outlet 122 (on the heat exchanger side of the valve 124), through a pump 195 and returns to the coolant inlet 121 (on the heat exchanger side of the valve 123). In some embodiments, the bypass line 190/191 may have isolation valves 192, 194 that are provided proximate to the respective connections between the bypass line 190 and the coolant outlet 122, and the bypass line 191 and the coolant inlet 121, respectively. The valves 123, 124, 192, 193 may be remotely operable valves that are operated by the HVAC controller 1009, depending upon the desired operation of the HVAC system.

During normal operations of the HVAC system 100 (e.g. providing heated or cooled air to the passenger compartment) valves 123, 124 are open and valves 192, 193 are shut (FIG. 5) which allows a continuous flow of coolant through the heat exchanger 120 (flows P and R), such as when it is desired to provide cool air (which may be air conditioning) or simply air flow through the HVAC and into the passenger compartment.

The HVAC 100 may be set up for local coolant circulation as is depicted in FIG. 6. This, similar to the HVAC 10 discussed above (FIG. 4) the local coolant circulation allows for heat for the passenger compartment to provide heat to the intake air (flow Z, FIG. 6) that flows across the heat exchanger 120 to minimize or eliminate the need to operate the heating module 130—which draws current from the vehicle's battery when operating on electricity (either a fully electric vehicle or a hybrid vehicle operating with electrical power currently).

As depicted in FIG. 6, the inlet valve 72 may be opened which allows recirc. air from the passenger compartment to flow through the air inlet portion 42 and across the lower portion 120a of the heat exchanger 120 (and specifically the portion M of the heat exchanger with hatching on FIG. 6 that extends from 8 o'clock to 2 o'clock on a clock face). During this mode of operation valves 123 and 124 are shut, which prevents the coolant within the heat exchanger 120 from flowing back to the chiller (or radiator) to remove the heat from the coolant. Instead, valves 192 and 193 are open and the pump operates 195, which causes flow from section 190 to section 191 of the bypass line, and therefore causes coolant to flow into the heat exchanger at the lower portion 120a and flow upwardly through the heat exchanger 120 to the upper portion 120b.

Air (Z) from the HVAC fan 205 flows across the heat exchanger 120 (and specifically across the upper portion 120b of the heat exchanger 120 (and specifically the portion N with hatches that extend from 10 o'clock to 4 o'clock on the clock face). Because the coolant flows in the direction R through the heat exchanger 120, the coolant receives heat from the recirc. air (Y) that flows across portion M (the recirc. air flows from the relatively warm passenger compartment into the inlet line 42 and to the heat exchanger), which increases the temperature of the coolant. The coolant that reaches the upper portion 120b (M) has an increased temperature and therefore heat transfers from the coolant to the air Z that flows from the HVAC fan 205, thereby increasing the temperature of the air ZZ that leaves the heat exchanger 120 and travels to the desired outlet path (typically in this instance the defrost-air flow A (FIGS. 1, 2).

Depending upon the temperature difference between the air Z and the passenger compartment air X, the air ZZ may need to be further heated by the HVAC heater 130 to reach a temperature needed for suitable defrost, but the introduction of heat from the heat exchanger 120 minimizes the amount of heat needed by the HVAC heater 130—thereby limiting the current draw from the battery to operate the defrost. In some embodiments, particularly after sufficient time of operating the system 100 in the configuration of FIG. 6 (as well as the system 10 in the configuration of FIG. 4), the HVAC controller may determine that the air temperature ZZ (which was further heated after the heat exchanger 120 (20) by the HVAC heater 130 (30)) is such that it no longer needs the extra heat from the HVAC heater 130, 30 and the HVAC controller 1009 may turn off the HVAC heater 130/30 and may redirect the air ZZ within the HVAC to bypass the HVAC heater.

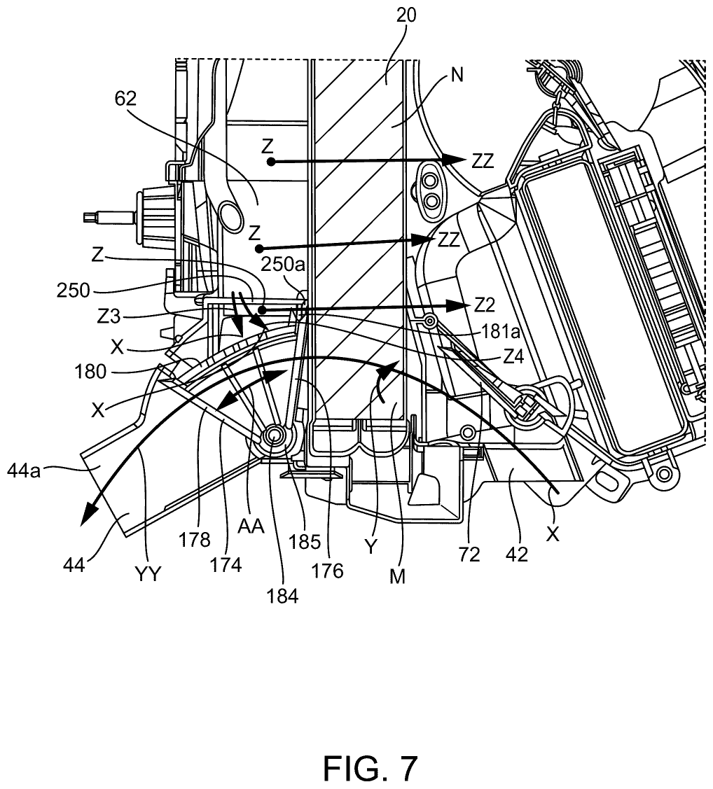

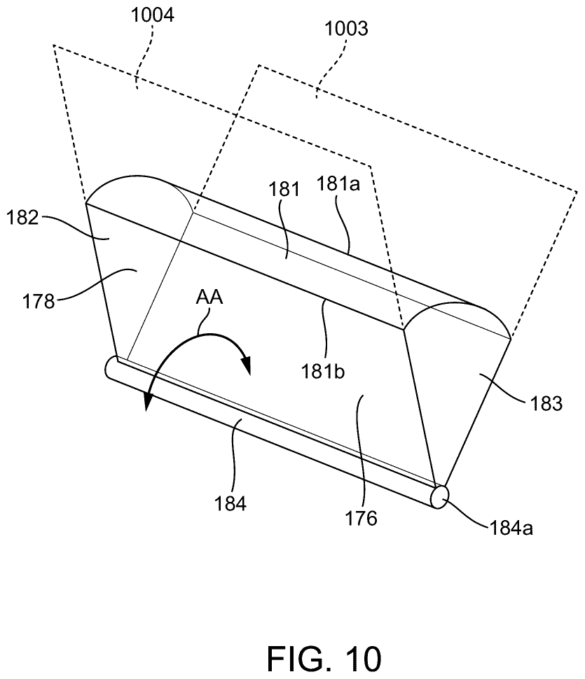

Turning now to FIGS. 7-10, the HVAC system 100 is provided with a preferred outlet valve 174, which is within the outlet 44 of the relief air flow path, which is a barrel valve. The barrel valve 174 may be provided instead of the flapper valve 74 (second valve) that is depicted in FIGS. 2-6. The barrel valve 174 includes an inlet aperture 176, and outlet aperture 178, and a circumferential blocking portion 180 that extends between the inlet and outlet apertures 176, 178. With reference to FIG. 10, the inlet aperture 176 is aligned along plane 1003 and the outlet aperture 178 is aligned along plane 1004. The circumferential blocking portion 180 establishes a flow path AA within the barrel valve 174 between the inlet and outlet apertures 176, 178, and the blocking portion 180 blocks air flow into the air flow path AA other than from the inlet and outlet apertures 176, 178.

The blocking portion 180 may include a curved circumferential portion 181 that extends between top edges of the inlet and outlet apertures 176, 178. The circumferential portion 181 may be a continuous curve (i.e. the same radius) along the entire length of the blocking portion between the inlet and outlet apertures 176, 178. In other embodiments, a portion of the circumferential portion 181 may be a continuous curve, while another portion may be at a different continuous curve, and/or a discontinuous curve. The geometry of the circumferential portion 181 may be provided to allow the valve 174 to freely move between the first and second positions within the outlet plenum 44 (discussed below) while maximizing the cross-sectional flow area within the flow path AA. One of ordinary skill in the art with a thorough review of the specification would be able to appropriately size and shape the blocking portion 180 (both the circumferential portion 181 and the side portions 182, 183 as discussed below) in view of the needed range of travel of the valve 174 and with respect to the space available within the outlet portion 44 of relief air path, just below the heat exchanger 20 inlet.

The blocking portion 180 includes a first and second side portions 182, 183 that extend inwardly from the circumferential portion 181 toward a center hub 184 and establish the side walls of the barrel valve 174. In some embodiments, the side portions 182, 183 extend toward a center hub 184 that receives a shaft 184a therethrough, with rotation of the shaft 184 causing rotation of the valve 174. The side portions 182, 183 prevent flow from extending therethrough and into the air flow path AA. The side portions 182, 183 may be parallel to each other and spaced apart a distance that is just less than a width of the outlet plenum 44 (with the width being the distance into and out of the page in the view of FIGS. 6 and 7). The barrel valve 174 may be sized such that the side portions 182, 183 are closely proximate to, in in some embodiments in contact with, the side walls (44a, 44b) of the outlet plenum 44.

Like the valve 74 discussed above, the outlet (second) valve 174 is positionable in a first position (i.e. the third position as identified in the as-filed claims with this specification) that allows air flow into the inlet aperture 176, through the air flow path AA, and out the outlet aperture 178 and into the outlet relief flow path 44. The barrel valve 174 is positioned such that when in the first position (FIG. 7) air that enters into the inlet aperture 176 from the heat exchanger 20 (air flow path Y-FIG. 7), and specifically the portion of the heat exchanger 20 that is aligned with the inlet aperture 176 (M-FIG. 7) flows through the flow path AA and leaves the outlet aperture 178. The air that flows through the outlet aperture continues to flow through the outlet portion 44, as discussed above.

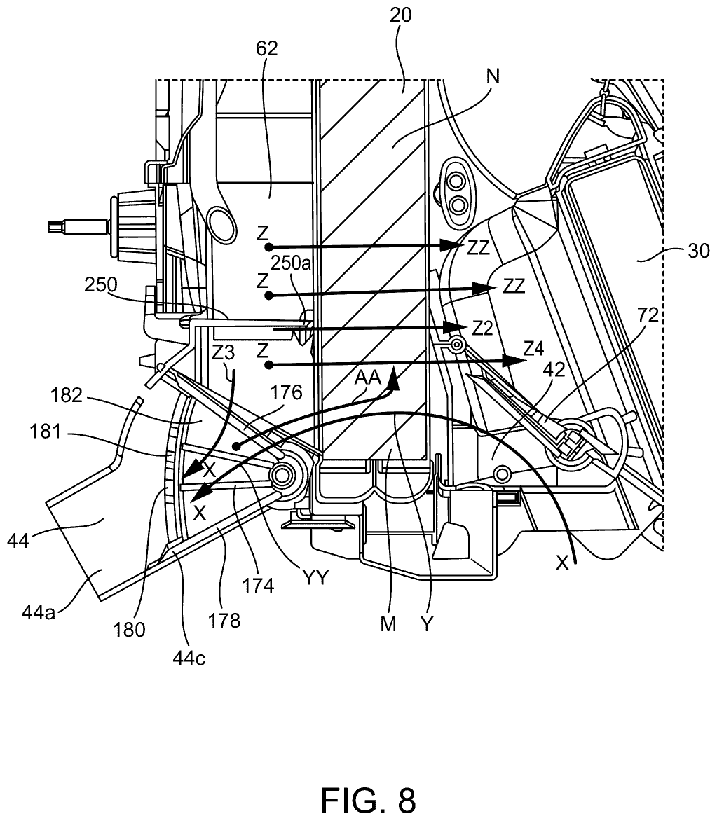

When the valve 174 is in the first position (FIG. 7), air that approaches the inlet plenum 62 of the heat exchanger 20 (which flows from an air inlet and a fan within the HVAC-upstream of the heat exchanger in the typical air flow path through the HVAC system- and initially flows in a direction out of the page that FIG. 7 is printed on) is blocked by the blocking portion 180 from flowing into the outlet portion 44 or the air relief system, as schematically depicted as flow Z3 in FIG. 7. Air flow that approaches the inlet plenum 62 of the heat exchanger 20 is also blocked by the blocking portion 180 from flowing into the portion of the heat exchanger 20 that is aligned with the inlet opening 176 of the valve 174 (portion M), as can be understood with reference to FIGS. 7-8.

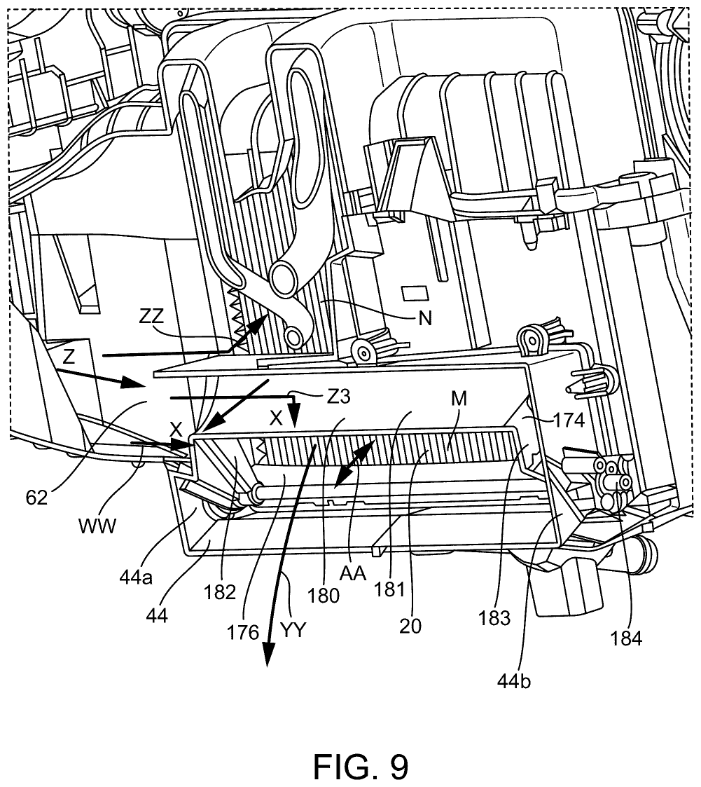

In some embodiments, the valve 174 is aligned within the HVAC system such some air enters that an inlet plenum 62 proximate to the barrel valve 174 approaches one or the other of the side portions 182, 183 of the barrel valve 174. The presence of the side portions 182, 183 prevents air from entering into the air flow path AA within the valve 174 from the sides (as depicted with arrow WW on FIG. 9, which flows from the inlet plenum 62 but is blocked by the side portion 182), as well as the circumferential portion 181 prevents air entering therethrough (flow Z3) as discussed above.

When the barrel valve 174 is in the second position (FIG. 8), the barrel valve 174 has rotated (or moved in embodiments where the valve does not purely rotate) such that the circumferential portion 181 becomes aligned within the outlet portion 44 to block air flow that flows through the heat exchanger 20 (portion M) and into the air flow path AA from continuing to flow through the outlet portion 44, as schematically depicted by air flow path YY being blocked by the circumferential portion 181. As understood with respect to FIG. 8, in the second position, the inlet aperture 176 rotates away from the heat exchanger 20 and becomes aligned with the inlet plenum 62 proximate to the inlet of the heat exchanger 20, such that air from the inlet plenum 62 can flow into the air flow path AA (air flow Z3-FIG. 8), but the circumferential portion 181 blocks the air Z3 from flowing therepast and through the outlet portion 44.

As also shown in FIG. 8, when the valve 174 is in the second position air from the plenum 62 can flow into the portion M of the heat exchanger 20 that is aligned with the inlet aperture 176 when the barrel valve 174 is in the first position (shown schematically as flow Z4 in FIG. 8.

In some embodiments, the HVAC housing may include a support 250 that extends through the air inlet plenum 62. The support 250 is provided to include an edge portion 250a that a top edge 181a of the circumferential portion 181 that forms the top edge of the inlet opening 176 rests against when the barrel valve 174 is in the first position (FIG. 7) to ensure that the barrel valve 174 is properly maintained in the first position. The edges of the first and second walls 182, 183 and the opposite edge 182b of the circumferential portion 181 contact the floor (44c) of the relief outlet 44 when the barrel valve 174 has reached the second position, as show in FIG. 8. FIG. 7 depicts that in some embodiments, there is a space between the circumferential portion 181 and the support to allow some air Z from the plenum 62 to flow through the heat exchanger below the support 250 (schematic flow Z2-FIG. 7).

In some embodiments, the HVAC system is controlled such that the inlet (first) valve 42 is in the closed position (i.e. preventing flow through the inlet portion 44) so that the air from the inlet plenum 62 that flows through the portion of the heat exchanger 20 (FIG. 8, flow path Z4 (although FIG. 8 shows the valve 42 open, and not shut as described herein)) that leads to the inlet plenum 42 is blocked from flowing into the inlet plenum 42 and instead flows into the HVAC assembly for direction therewithin as controlled by the HVAC controller 1009.

In some embodiments, the first valve 74, which is within the inlet 42 of the relief air flow path, may be formed as a barrel valve that is exactly like or similar to the barrel valve 174 that is in the relief outlet 44 (discussed above). The term “substantially the same” includes the exact same construction, as well as a construction with the same features but somewhat different sizes and geometries as necessitated by the different environments that the first and second valves are disposed in with in the relief system. In this embodiment, the barrel valve is positioned such that air flow inlets and outlets (like 176, 178) allow flow through an internal air flow path (like AA) to allow air from the passenger compartment to reach the heat exchanger 20 (at the position M). When the first valve 72 is in the second position, the valve 72 is moved (in some embodiments rotated) such that the blocking portion (180, and specifically a portion that is the same as or similar to the circumferential portion 181) is disposed within the air inlet 42 to prevent air to flow past the blocking portion 180. The first valve 74 (when a barrel valve) is controlled by the HVAC controller 1009.

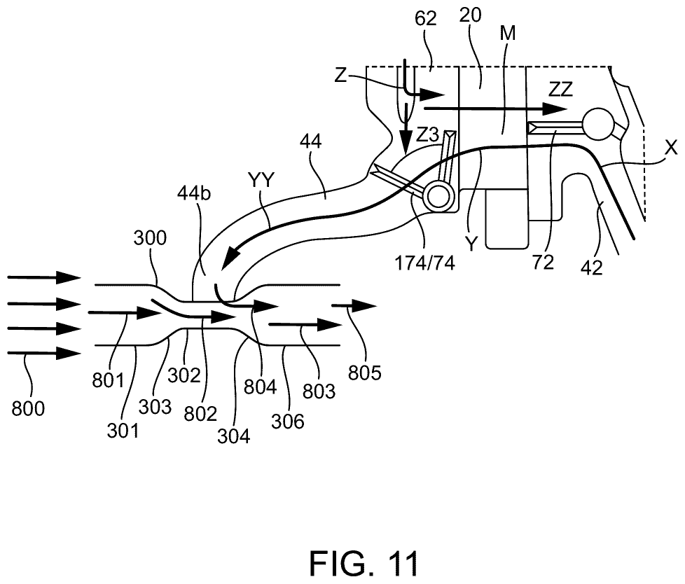

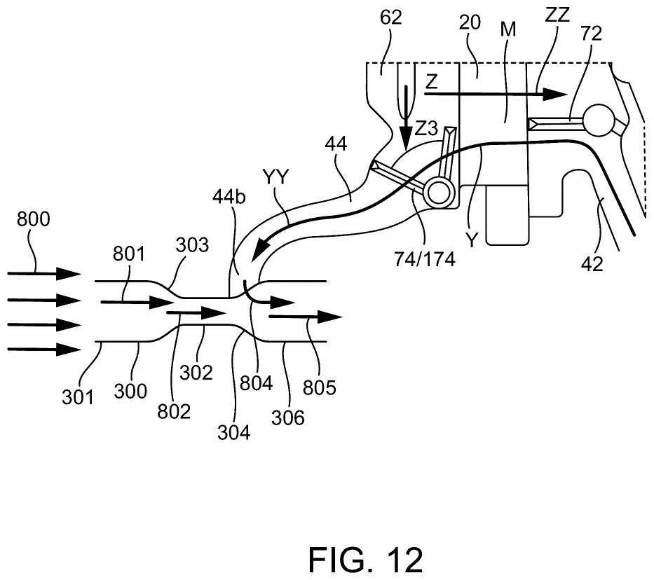

Turning now to FIGS. 11-12, some embodiments, the relief outlet 44 may extend to an end 44b that is disposed at a position that has a negative pressure (vacuum) during operation of the vehicle. In some embodiments, the end 44b is connected with a venturi 300. Specifically, the end 44b is connected with the neck portion 302 (i.e. a portion of lower cross-sectional area than an inlet 301) of the venturi (FIG. 11) or in some embodiments the end 44b may be connected just downstream of the neck portion 302 and specifically within a portion where the cross-sectional area of flow just starts to increase downstream of the smallest cross-sectional area of the neck 302 (FIG. 12).

The inlet portion 301 has a constant cross-sectional area, such as a constant diameter in embodiments where the venturi is cylindrical- or with a round cross-section. Alternatively, the inlet portion 301 may have a constant cross-sectional area along its length but the dimensions of the cross-section may change along the length. The neck portion 302 has a cross-sectional area gradually reduces along the length of the neck portion (decreasing part of neck portion-303) to a position with a smallest cross-sectional area. In some embodiments, the neck portion maintains a circular cross-sectional area (with a changing diameter along its length), while in other embodiments, the neck may have a changing shape along its length, which results in a decreasing cross-sectional area along the length of the neck.

In some embodiments once the neck portion 302 reaches the smallest cross-sectional area the cross-sectional area may be maintained constant for length of the venturi. In other embodiments, the cross-sectional area along the neck may begin increasing after reaching the smallest cross-sectional area (304). After increasing the venturi may reach a cross-sectional area that is constant either at the same cross-sectional area (306) as the inlet portion 301, or in some embodiments somewhat smaller than the cross-sectional area of the inlet portion 301.

The venturi 300 is positioned within the vehicle such that as the vehicle moves in the forward direction (based upon the design of the vehicle for driving in the forward direction) air 800 (schematic) enters into the inlet 301 of the venturi 300 due to the relative motion of the vehicle with respect to the outside air as the vehicle moves, which causes the air to be moving relative to the fixed components within the vehicle such as the venturi 300. The air enters into the inlet 301 (801, schematic) at a given velocity, which is equal to the velocity difference between the vehicle and air outside of the vehicle. The air flows with a constant velocity through the inlet portion 301, but as the air enters the neck 302, the velocity of the air increases due to the decrease of the cross-sectional flow area within the neck. Due to conservation of mass principles, as the velocity of the air increases, the pressure of the air decreases within the neck 302 (air flow 802, schematic). The velocity of the air continues to increase and the pressure of the air continues to decrease within the neck.

When the air reaches the smallest diameter within the neck, the velocity of air flow through the venturi 300 is the highest and the pressure of the air is the lowest. When air reaches the increasing section 304, the velocity of the air starts to decrease and the pressure of the air increases due to conservation of mass principles.

Due to the connection between the end 44b of the relief outlet 44 and the neck 302 (or just past the neck 303, i.e. in portion of the path where the cross-sectional area just starts to increase after the neck-FIG. 12), the below ambient pressure that exists within the neck 302 is communicated into the relief outlet 44. The relief outlet 44 will therefore be at a pressure below the atmospheric pressure of the air surrounding the vehicle. Because the passenger compartment, from which the relief inlet 42 draws air into is either at atmospheric pressure, or often is at a positive pressure above atmospheric pressure during the operation of the HVAC fan that urges air through the HVAC system and into the passenger compartment, a differential pressure will exist between the recirculation inlet 42 and the relief outlet 44. This differential pressure will cause air to flow from the passenger compartment into the relief inlet 42, and into the relief outlet 44, which will urge air to flow through the heat exchanger 20 flow path Y through the portion M—as discussed above. The air that flows from the relief outlet end 44b and into the neck 302 (air flow 804) (or just downstream of the neck (304, FIG. 12)) will be pulled into the outlet section 306 of the venturi and out of the venturi as entrained with the air that flows through the venturi (800, 801, 802, 803, 805)—the air collectively leaving the venturi is schematically shown as 805.

Because the decrease in air pressure within the neck 302 of the venturi 300 is a function of vehicle speed, as the vehicles speed increases, the flow rate of air (800) into the inlet 301 of the venturi also increases, which causes the pressure within neck to further decrease. This increases the differential pressure between the pressure within the passenger compartment (inlet of inlet portion 42) and the pressure at the end 44b of the outlet 44, which increases the air flow from the passenger compartment and through the inlet and outlet portions 42, 44, and through the heat exchanger 20. This increase in air flow through the heat exchanger 20, provides for more heat from the recirc air flow through the heat exchanger 20 to be transferred to the refrigerant/coolant within the heat exchanger (as discussed above), which results in additional heat from the cabin being transferred to the outside air that flows through the heat exchanger 20 (flow ZZ-discussed above) to preheat the outside air that is being introduced into the passenger compartment during this mode of operation of the HVAC system, as discussed above.

As depicted in FIGS. 11 and 12, and as discussed above, in some embodiments, the outlet valve within the relief outlet 44 may be a barrel valve 174, like the barrel valve 174 discussed with above and depicted in FIGS. 7-10. The barrel valve 174 includes a blocking portion 180, with a circumferential surface 181 and opposite first and second sides 182, 183, which, when the barrel valve 174 is in the first position (position depicted in FIGS. 11 and 12) allows air flow through the relief system from the passenger compartment, through the heat exchanger (area M) and out the outlet 44 and into the venturi 300, but blocks flow from the inlet plenum 62 and into the relief outlet 44 (flow Z3, FIGS. 7, 11, 12). Accordingly, due to the barrel valve 174 blocking flow from the inlet plenum 62, the negative pressure that is felt at the relief outlet 44b does not draw air from the inlet plenum 62 into the relief outlet. The term “does not draw air” includes no air flowing as well as allowing for some di minimus flow of air due to imperfect connections between the surfaces of the barrel valve 174 and the plenum 44 due to tolerances or normal wear during use.

In some embodiments, the inlet relief path 42 may include an isolation valve, that operates like the inlet valves discussed in the embodiments above.

The term “about” is specifically defined herein to include a range that includes the reference value and plus or minus 5% of the reference value. The term “substantially the same” is when the item under comparison is within 5% of the aspect of the reference value of the item.

The computing elements or functions, such as the HVAC controller or the vehicle controller disclosed herein may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification is readily understood with reference to the following Numbered Paragraphs:

Numbered Paragraph 1: A HVAC system for a vehicle, comprising:
a first air inlet configured, when installed within a vehicle, to receive air that flows therein from outside of the vehicle;
a second air inlet different from the first air inlet, the second air inlet configured, when installed within the vehicle, to receive air that flows therein from within a passenger compartment of the vehicle;
a heat exchanger disposed to receive air from the first air inlet and the second air inlet via different flow paths simultaneously.

Numbered Paragraph 2: The HVAC system for a vehicle of Numbered Paragraph 1, wherein the heat exchanger is an evaporator for a heat pump system or an air conditioning system.

Numbered Paragraph 3: The HVAC system for a vehicle of either of Numbered Paragraphs 1 or 2, wherein the first air inlet is positioned to cause air flow through the heat exchanger at a first position within the heat exchanger that is vertically above a second position within the heat exchanger, wherein the second air inlet is positioned to cause air flow through the heat exchanger at the second position.

Numbered Paragraph 4: The HVAC system for a vehicle of Numbered Paragraph 3, wherein the first air inlet is positioned to cause air flow through the heat exchanger in a first direction, and the second air inlet is positioned to cause air flow through the heat exchanger in a second direction that is substantially opposite to the first direction.

Numbered Paragraph 5: The HVAC system for a vehicle of any one of Numbered Paragraphs 1-4, further comprising a first air outlet configured to receive air from the heat exchanger that flowed into the heat exchanger from the second air inlet.

Numbered Paragraph 6: The HVAC system for a vehicle of Numbered Paragraph 5, wherein the first air outlet is aligned to cause air that flows into the first air outlet to flow outside of the vehicle.

Numbered Paragraph 7: The HVAC system for a vehicle of either of Numbered Paragraphs 5 or 6, wherein the second air inlet comprises a first valve disposed therein, wherein the first valve is positionable in a first position to allow air to flow into the heat exchanger from the second air inlet, and a second position to prevent or substantially prevent air to flow into the heat exchanger from the second air inlet.

Numbered Paragraph 8: The HVAC system for a vehicle of any one of Numbered Paragraphs 5, 6, or 7, wherein the first air outlet comprises a second valve disposed therein, wherein the second valve is positioned in a third position to allow air flow through the first air outlet, and fourth position to substantially prevent air to flow though first air outlet.

Numbered Paragraph 9: The HVAC system for a vehicle of Numbered Paragraph 8, wherein the second valve is controlled such that the second valve is in the third position when the first valve is in the first position, and the second valve is in the fourth position when the first valve is in the second position.

Numbered Paragraph 10: The HVAC system for a vehicle of Numbered Paragraph 7, further comprising a third valve that is disposed within the first air outlet and positioned downstream of the second valve, such that air flowing from the heat exchanger and into the first air outlet flows past the second valve before flowing to the third valve.

Numbered Paragraph 11: The HVAC system for a vehicle of Numbered Paragraph 10, wherein the third valve is a check valve that is configured to allow flow therepast through the first air outlet and from the heat exchanger, and substantially prevent air to flow into the first air outlet flowing directly from outside of the vehicle.

Numbered Paragraph 12: The HVAC system for a vehicle of either of Numbered Paragraphs 10 or 11, wherein the third valve is positioned proximate to an opening in the first air outlet that allows flow from the first air outlet to outside of an enclosed portion of the vehicle.

Numbered Paragraph 13: The HVAC system for a vehicle of Numbered Paragraph 12, wherein the opening in the first air outlet is positioned at a location that is at a pressure below atmospheric pressure when the vehicle is moving in a forward driving direction.

Numbered Paragraph 14: The HVAC system for a vehicle of Numbered Paragraph 12, wherein the opening of the first air outlet is provided within a wheel-well of a vehicle and behind a tire of the vehicle.

Numbered Paragraph 15: The HVAC system for a vehicle of any one of Numbered Paragraphs 8-14, wherein the position of both of the first and second valves are operated by an HVAC controller.

Numbered Paragraph 16: The HVAC system for a vehicle of any one of Numbered Paragraphs 8-15, wherein the heat exchanger is a portion of a heat pump system, wherein when the HVAC system is operated to add heat to the air that flows through the first air inlet, the heat exchanger is an evaporator of the heat pump system, wherein the evaporator receives refrigerant therein.

Numbered Paragraph 17: The HVAC system for a vehicle of Numbered Paragraph 16, wherein when the first and second valves are in the respective first and third positions, the heat pump system is configured to operate such that a compressor within the heat pump system does not operate to cause movement of the refrigerant within the evaporator,
wherein when the HVAC system is operated to add heat to the air that flows from the first air inlet past the heat exchanger, flow of air from the second inlet through the heat exchanger and toward the first outlet transfers heat from the air to the refrigerant within the heat exchanger proximate to the air flow from the second inlet to the first outlet, which causes refrigerant proximate to the air flow from the second inlet to the second outlet to travel upwardly within the heat exchanger to a position proximate to an air flow across the heat exchanger from the first air inlet such that the refrigerant proximate the first inlet thermally interacts with air traveling past the heat exchanger from the first air inlet.

Numbered Paragraph 18: The HVAC system of Numbered Paragraph 17, wherein the heat pump system comprises first and second flow valves disposed within respective inlet and outlet refrigerant lines outside of the heat exchanger that allow flow of a refrigerant through the heat exchanger with the first flow valve disposed at a refrigerant inlet to the heat exchanger, and a second flow valve disposed at a refrigerant outlet from the heat exchanger, wherein when the heat exchanger operates with the natural circulation the first and second flow valves are positioned such that refrigerant does not flow through the respective first and second flow valves.

Numbered Paragraph 19: The HVAC system of Numbered Paragraph 18, wherein the first flow valve is an expansion valve of the heat pump system.

Numbered Paragraph 20: The HVAC system for a vehicle of Numbered Paragraph 8, wherein the heat exchanger is disposed within a circulating coolant flow path, wherein coolant flows into the heat exchanger at an inlet at or proximate to a lower portion within the heat exchanger and coolant flows out of the heat exchanger at or proximate to a higher portion within the heat exchanger, such that coolant flowing through the heat exchanger interacts with air flowing from the second inlet before interacting with air flowing from the first inlet as coolant flows through the heat exchanger.

Numbered Paragraph 21: The HVAC system for a vehicle of Numbered Paragraph 20, further comprising a pump within the circulating coolant flow path that, during operation when the HVAC system is desired to provide heat to the air flowing from the first air inlet, the pump causes flow within the circulating flow path such that coolant enters the heat exchanger at the inlet and leaves the heat exchanger though the outlet.

Numbered Paragraph 22: The HVAC system of Numbered Paragraph 21, further comprising a bypass line that connects to the coolant flow with a first connection proximate to the inlet of the heat exchanger and a second connection proximate to the outlet of the heat exchanger, and a pump within the bypass line that urges flow from the outlet of the heat exchanger to the inlet of the heat exchanger, and further comprising a fourth isolation upstream of a connection between the bypass line and the inlet and a fifth isolation valve downstream of a connection between the bypass line and the outlet, wherein the fourth and fifth isolation valves are shut and the pump operates when the first and second valves are open.

Numbered Paragraph 23: The HVAC system of Numbered Paragraph 6, wherein a first valve is provided in one of the second air inlet or the first air outlet, wherein the first valve is positionable to a first position to allow air to flow into the heat exchanger from the second air inlet and from the heat exchanger to the second air outlet, and a second position to prevent or substantially prevent air to flow from the heat exchanger to the first air outlet.

Numbered Paragraph 24: The HVAC system for a vehicle of Numbered Paragraph 23, further comprising a second valve that is disposed within the first air outlet and positioned downstream of the first valve, such that air flowing from the heat exchanger and into the first air outlet flows past the first valve before flowing to the second valve.

Numbered Paragraph 25: The HVAC system for a vehicle of Numbered Paragraph 24, wherein the second valve is a check valve that is configured to allow flow therepast through the first air outlet and from the heat exchanger, and substantially prevent air to flow into the first air outlet flowing directly from outside of the vehicle.

Numbered Paragraph 26: The HVAC system for a vehicle of Numbered Paragraph 25, wherein the second valve is positioned proximate to an opening in the first air outlet that allows flow from the first air outlet to outside of an enclosed portion of the vehicle.

Numbered Paragraph 27: The HVAC system for a vehicle of Numbered Paragraph 26, wherein the opening in the first air outlet is positioned at a location that is at a pressure below atmospheric pressure when the vehicle is moving in a forward driving direction.

Numbered Paragraph 28: The HVAC system for a vehicle of Numbered Paragraph 26, wherein the opening of the first air outlet is provided within a wheel-well of a vehicle and behind a tire of the vehicle.

Numbered Paragraph 29: The HVAC system for a vehicle of any one of Numbered Paragraphs 23-28, wherein the position of the first valve is operated by an HVAC controller.

Numbered Paragraph 30: The HVAC system for a vehicle of any one of Numbered Paragraphs 23-29, wherein the heat exchanger is a portion of a heat pump system, wherein when the HVAC system is operated to add heat to the air that flows through the first air inlet, the heat exchanger is an evaporator of the heat pump system, wherein the evaporator receives refrigerant therein.

Numbered Paragraph 31: The HVAC system for a vehicle of Numbered Paragraph 30, wherein when the first valve is in the first position, the heat pump system is configured to operate such that a compressor within the heat pump system does not operate to cause movement of the refrigerant within the evaporator, wherein when the HVAC system is operated to add heat to the air that flows from the first air inlet past the heat exchanger, flow of air from the second inlet through the heat exchanger and toward the first outlet transfers heat from the air to the refrigerant within the heat exchanger proximate to the air flow from the second inlet to the first outlet, which causes refrigerant proximate to the air flow from the second inlet to the second outlet to travel upwardly within the heat exchanger to a position proximate to an air flow across the heat exchanger from the first air inlet such that the refrigerant proximate the first inlet thermally interacts with air traveling past the heat exchanger from the first air inlet.

Numbered Paragraph 32: The HVAC system of Numbered Paragraph 31, wherein the heat pump system comprises first and second flow valves disposed within respective inlet and outlet refrigerant lines outside of the heat exchanger that allow flow through the heat exchanger with the first flow valve disposed at a refrigerant inlet to the heat exchanger, and a second flow valve disposed at a refrigerant outlet from the heat exchanger, wherein when the heat exchanger operates with the natural circulation the first and second flow valves are positioned such that refrigerant does not flow through the respective first and second flow valves.

Numbered Paragraph 33: The HVAC system of Numbered Paragraph 32, wherein the first flow valve is an expansion valve of the heat pump system.

Numbered Paragraph 34: The HVAC system for a vehicle of Numbered Paragraph 8, wherein the heat exchanger is disposed within a circulating coolant flow path, wherein coolant flows into the heat exchanger at an inlet at or proximate to a lower portion within the heat exchanger and coolant flows out of the heat exchanger at or proximate to a higher portion within the heat exchanger, such that coolant flowing through the heat exchanger interacts with air flowing from the second inlet before interacting with air flowing from the first inlet as coolant flows through the heat exchanger.

Numbered Paragraph 35: The HVAC system for a vehicle of Numbered Paragraph 34, further comprising a pump within the circulating coolant flow path that, during operation when the HVAC system is desired to provide heat to the air flowing from the first air inlet, the pump causes flow within the circulating flow path such that coolant enters the heat exchanger at the inlet and leaves the heat exchanger though the outlet.

Numbered Paragraph 36: The HVAC system of Numbered Paragraph 35, further comprising a bypass line that connects to the coolant flow with a first connection proximate to the inlet of the heat exchanger and a second connection proximate to the outlet of the heat exchanger, and a pump within the bypass line that urges flow from the outlet of the heat exchanger to the inlet of the heat exchanger, and further comprising a fourth isolation upstream of a connection between the bypass line and the inlet and a fifth isolation valve downstream of a connection between the bypass line and the outlet, wherein the fourth and fifth isolation valves are shut and the pump operates when the first and second valves are open.

Numbered Paragraph 37. The HVAC system for a vehicle of Numbered Paragraph 8, wherein the second valve is a barrel valve, wherein the barrel valve comprises an inlet aperture, and outlet aperture, and blocking portion establishes a flow path between the inlet and outlet apertures, the blocking portion prevents air flow into the flow path other than from the inlet and outlet apertures.

Numbered Paragraph 38. The HVAC system for a vehicle of Numbered Paragraph 37, wherein when the second valve is disposed in the third position the inlet aperture is aligned with the heat exchanger and the outlet aperture is aligned to allow air flowing through the flow path to flow through the first air outlet, and wherein when the second valve is disposed in the fourth position the blocking portion is aligned within the first air outlet to prevent air flow from the heat exchanger through the first air outlet.

Numbered Paragraph 39. The HVAC system for a vehicle of Numbered Paragraph 37, wherein the blocking portion blocks air flow from the first air inlet to the first air outlet when the second valve in the third position and in the fourth position.

Numbered Paragraph 40. The HVAC system for a vehicle of Numbered Paragraph 37, wherein the blocking portion is withdrawn from proximate to the heat exchanger when the second valve is in the fourth position, such that the second valve does not block air flow from the first air inlet to the heat exchanger when the second valve is in the fourth position.

Numbered Paragraph 41. The HVAC system for a vehicle of Numbered Paragraph 37, wherein the blocking portion comprises a curved circumferential portion that extends between the inlet aperture and the outlet aperture, and further comprises parallel and spaced apart first and second side panels that extend between the inlet aperture and outlet aperture.

Numbered Paragraph 42. The HVAC system for a vehicle of Numbered Paragraph 41, wherein curved circumferential portion extends at a constant curve between the inlet aperture and the outlet aperture.

Numbered Paragraph 43. The HVAC system for a vehicle of Numbered Paragraph 6, wherein the first air outlet comprises a second valve disposed therein, wherein the second valve is positioned in a third position to allow air flow through the first air outlet, and fourth position to substantially prevent air to flow though first air outlet,
wherein the second valve is a barrel valve, wherein the barrel valve comprises an inlet aperture, and outlet aperture, and blocking portion establishes a flow path between the inlet and outlet apertures, the blocking portion prevents air flow into the flow path other than from the inlet and outlet apertures.

Numbered Paragraph 44. The HVAC system for a vehicle of any one of Numbered Paragraphs 37-43, wherein the first valve is a barrel valve and is constructed substantially in the same manner as the second valve.

Numbered Paragraph 45. The HVAC system of any one of Numbered Paragraphs 37-44, wherein the first air inlet also is configured to receive air that flows from the passenger compartment of the vehicle, wherein further comprising a valve within the first air inlet that provides for air flow from outside the vehicle, or from inside the passenger compartment, or a portion of air from outside the vehicle and a portion of air from the passenger compartment.

Numbered Paragraph 46. A HVAC system for a vehicle, comprising:
a first air inlet configured, when installed within a vehicle, to receive air that flows therein from outside of the vehicle;
a second air inlet different from the first air inlet, the second air inlet configured, when installed within the vehicle, to receive air that flows therein from within a passenger compartment of the vehicle;
a heat exchanger disposed to receive air from the first air inlet and the second air inlet via different flow paths simultaneously,
further comprising a first air outlet configured to receive air from the heat exchanger that flowed into the heat exchanger from the second air inlet, the first air outlet is aligned to cause air that flows into the first air outlet to flow outside of the vehicle, the air leaves the first air outlet at an end portion,
a second air flow path with an air inlet and an air outlet, the second air flow path is positioned upon the vehicle such that outside air flows into the air inlet and out of the air outlet when the vehicle moves in a forward direction, wherein the air inlet is connected to a first portion at a constant first cross-sectional area, the first portion is connected to a second portion with a cross-sectional area that decreases below the first cross-sectional area along its length, the second portion is connected to a third portion with a cross-sectional area that increases for at least a portion of its length,
wherein the first air outlet is connected to the second air flow path, such that air from the first air outlet flows into the second air flow path.

Numbered Paragraph 47. The HVAC system for a vehicle of Numbered Paragraph 46, wherein the air from the first outlet enters into the second air flow path in the second portion.

Numbered Paragraph 48. The HVAC system for a vehicle of Numbered Paragraph 46, wherein the air from the first outlet enters into the second air flow path in the third portion.

Numbered Paragraph 49. The HVAC system for a vehicle of Numbered Paragraph 48, wherein the air from the first outlet enters into the second air flow path in the third portion just past an interface between the second portion and the third portion.

Numbered Paragraph 50. The HVAC system for a vehicle of Numbered Paragraph 47, further comprising a valve within the first air outlet that is movable from a first position that allows air from the heat exchanger and through the first air outlet to the end portion of the first air outlet, and a second position that prevents air from flowing from the heat exchanger and through the first air outlet to reach the end portion of the first air outlet.

Numbered Paragraph 51. The HVAC system for a vehicle of Numbered Paragraph 50, wherein the valve is a barrel valve, wherein the barrel valve comprises an inlet aperture, and outlet aperture, and blocking portion establishes a flow path between the inlet and outlet apertures, the blocking portion prevents air flow into the flow path other than from the inlet and outlet apertures,
wherein when the barrel valve is in the second position, the blocking portion blocks air flow from the first air inlet from flowing through the first outlet portion to the first air outlet.

Numbered Paragraph 52. The HVAC system for a vehicle of Numbered Paragraph 51, wherein the blocking portion is withdrawn from proximate to the heat exchanger when the barrel valve is in the second position, such that the barrel valve does not block air flow from the first air inlet to the heat exchanger.

Numbered Paragraph 53. The HVAC system for a vehicle of Numbered Paragraph 52, wherein the blocking portion comprises a curved circumferential portion that extends between the inlet aperture and the outlet aperture, and further comprises parallel and spaced apart first and second side panels that extend between the inlet aperture and outlet aperture.

Numbered Paragraph 54. The HVAC system for a vehicle of any one of Numbered Paragraphs 46-53, wherein the heat exchanger is an evaporator for a heat pump system or an air conditioning system.

Numbered Paragraph 55. The HVAC system for a vehicle of any one of Numbered Paragraphs 46-54, wherein the first air inlet is positioned to cause air flow through the heat exchanger at a first position within the heat exchanger that is vertically above a second position within the heat exchanger, wherein the second air inlet is positioned to cause air flow through the heat exchanger at the second position.

Numbered Paragraph 56. The HVAC system for a vehicle of Numbered Paragraph 49, wherein the first air inlet is positioned to cause air flow through the heat exchanger in a first direction, and the second air inlet is positioned to cause air flow through the heat exchanger in a second direction that is substantially opposite to the first direction.

Numbered Paragraph 57. The HVAC system for a vehicle of any one of Numbered Paragraphs 46-53, wherein the heat exchanger is a portion of a heat pump system, wherein when the HVAC system is operated to add heat to the air that flows through the first air inlet, the heat exchanger is an evaporator of the heat pump system, wherein the evaporator receives refrigerant therein.

Numbered Paragraph 58. The HVAC system for a vehicle of Numbered Paragraph 57, wherein when the valve is in the first position, the heat pump system is configured to operate such that a compressor within the heat pump system does not operate to cause movement of the refrigerant within the evaporator,
wherein when the HVAC system is operated to add heat to the air that flows from the first air inlet past the heat exchanger, flow of air from the second inlet through the heat exchanger and toward the first outlet transfers heat from the air to the refrigerant within the heat exchanger proximate to the air flow from the second inlet to the first outlet, which causes refrigerant proximate to the air flow from the second inlet to the second outlet to travel upwardly within the heat exchanger to a position proximate to an air flow across the heat exchanger from the first air inlet such that the refrigerant proximate the first inlet thermally interacts with air traveling past the heat exchanger from the first air inlet.

Numbered Paragraph 59. The HVAC system of Numbered Paragraph 57, wherein the heat pump system comprises first and second flow valves disposed within respective inlet and outlet refrigerant lines outside of the heat exchanger that allow flow of a refrigerant through the heat exchanger with the first flow valve disposed at a refrigerant inlet to the heat exchanger, and a second flow valve disposed at a refrigerant outlet from the heat exchanger, wherein when the heat exchanger operates with the natural circulation the first and second flow valves are positioned such that refrigerant does not flow through the respective first and second flow valves.

Numbered Paragraph 60. The HVAC system for a vehicle of any one of Numbered Paragraphs 46-59, wherein the heat exchanger is disposed within a circulating coolant flow path, wherein coolant flows into the heat exchanger at an inlet at or proximate to a lower portion within the heat exchanger and coolant flows out of the heat exchanger at or proximate to a higher portion within the heat exchanger, such that coolant flowing through the heat exchanger interacts with air flowing from the second inlet before interacting with air flowing from the first inlet as coolant flows through the heat exchanger.

Numbered Paragraph 61. The HVAC system for a vehicle of Numbered Paragraph 60, further comprising a pump within the circulating coolant flow path that, during operation when the HVAC system is desired to provide heat to the air flowing from the first air inlet, the pump causes flow within the circulating flow path such that coolant enters the heat exchanger at the inlet and leaves the heat exchanger though the outlet.

Numbered Paragraph 62. The HVAC system of any one of Numbered Paragraphs 59-61, further comprising a bypass line that connects to the coolant flow with a first connection proximate to the inlet of the heat exchanger and a second connection proximate to the outlet of the heat exchanger, and a pump within the bypass line that urges flow from the outlet of the heat exchanger to the inlet of the heat exchanger, and further comprising a fourth isolation upstream of a connection between the bypass line and the inlet and a fifth isolation valve downstream of a connection between the bypass line and the outlet, wherein the fourth and fifth isolation valves are shut and the pump operates when the first and second valves are open.

Numbered Paragraph 63. The HVAC system of any one of Numbered Paragraphs 46-62, wherein the first air inlet also is configured to receive air that flows from the passenger compartment of the vehicle, wherein further comprising a valve within the first air inlet that provides for air flow from outside the vehicle, or from inside the passenger compartment, or a portion of air from outside the vehicle and a portion of air from the passenger compartment.

Numbered Paragraph 64. The HVAC system of any one of Numbered Paragraphs 1-45, further comprising a second air flow path with an air inlet and an air outlet, the second air flow path is positioned upon the vehicle such that outside air flows into the air inlet and out of the air outlet when the vehicle moves in a forward direction, wherein the air inlet is connected to a first portion at a constant first cross-sectional area, the first portion is connected to a second portion with a cross-sectional area that decreases below the first cross-sectional area along its length, the second portion is connected to a third portion with a cross-sectional area that increases for at least a portion of its length,
wherein the first air outlet is connected to the second air flow path, such that air from the first air outlet flows into the second air flow path.

Numbered Paragraph 65. The HVAC system for a vehicle of Numbered Paragraph 64, wherein the air from the first outlet enters into the second air flow path in the second portion.

Numbered Paragraph 66. The HVAC system for a vehicle of Numbered Paragraph 64, wherein the air from the first outlet enters into the second air flow path in the third portion.

Numbered Paragraph 67. The HVAC system for a vehicle of Numbered Paragraph 66, wherein the air from the first outlet enters into the second air flow path in the third portion just past an interface between the second portion and the third portion.

Numbered Paragraph 69. The HVAC system for a vehicle of Numbered Paragraph 65, further comprising a valve within the first air outlet that is movable from a first position that allows air from the heat exchanger and through the first air outlet to the end portion of the first air outlet, and a second position that prevents air from flowing from the heat exchanger and through the first air outlet to reach the end portion of the first air outlet.

Numbered Paragraph 70. The HVAC system for a vehicle of Numbered Paragraph 68, wherein the valve is a barrel valve, wherein the barrel valve comprises an inlet aperture, and outlet aperture, and blocking portion establishes a flow path between the inlet and outlet apertures, the blocking portion prevents air flow into the flow path other than from the inlet and outlet apertures,
wherein when the barrel valve is in the second position, the blocking portion blocks air flow from the first air inlet from flowing through the first outlet portion to the first air outlet.

Numbered Paragraph 71. The HVAC system for a vehicle of Numbered Paragraph 69, wherein the blocking portion is withdrawn from proximate to the heat exchanger when the barrel valve is in the second position, such that the barrel valve does not block air flow from the first air inlet to the heat exchanger.

Numbered Paragraph 72. The HVAC system for a vehicle of Numbered Paragraph 70, wherein the blocking portion comprises a curved circumferential portion that extends between the inlet aperture and the outlet aperture, and further comprises parallel and spaced apart first and second side panels that extend between the inlet aperture and outlet aperture.

Numbered Paragraph 73. The HVAC system for a vehicle of any one of Numbered Paragraphs 64-72, wherein the heat exchanger is an evaporator for a heat pump system or an air conditioning system.

Numbered Paragraph 74. The HVAC system for a vehicle of any one of Numbered Paragraphs 64-73, wherein the first air inlet is positioned to cause air flow through the heat exchanger at a first position within the heat exchanger that is vertically above a second position within the heat exchanger, wherein the second air inlet is positioned to cause air flow through the heat exchanger at the second position.

Numbered Paragraph 75. The HVAC system for a vehicle of Numbered Paragraph 67, wherein the first air inlet is positioned to cause air flow through the heat exchanger in a first direction, and the second air inlet is positioned to cause air flow through the heat exchanger in a second direction that is substantially opposite to the first direction.

Numbered Paragraph 76. The HVAC system for a vehicle of any one of Numbered Paragraphs 64-72, wherein the heat exchanger is a portion of a heat pump system, wherein when the HVAC system is operated to add heat to the air that flows through the first air inlet, the heat exchanger is an evaporator of the heat pump system, wherein the evaporator receives refrigerant therein.

Numbered Paragraph 77. The HVAC system for a vehicle of Numbered Paragraph 76, wherein when the valve is in the first position, the heat pump system is configured to operate such that a compressor within the heat pump system does not operate to cause movement of the refrigerant within the evaporator,
wherein when the HVAC system is operated to add heat to the air that flows from the first air inlet past the heat exchanger, flow of air from the second inlet through the heat exchanger and toward the first outlet transfers heat from the air to the refrigerant within the heat exchanger proximate to the air flow from the second inlet to the first outlet, which causes refrigerant proximate to the air flow from the second inlet to the second outlet to travel upwardly within the heat exchanger to a position proximate to an air flow across the heat exchanger from the first air inlet such that the refrigerant proximate the first inlet thermally interacts with air traveling past the heat exchanger from the first air inlet.

Numbered Paragraph 78. The HVAC system of Numbered Paragraph 76, wherein the heat pump system comprises first and second flow valves disposed within respective inlet and outlet refrigerant lines outside of the heat exchanger that allow flow of a refrigerant through the heat exchanger with the first flow valve disposed at a refrigerant inlet to the heat exchanger, and a second flow valve disposed at a refrigerant outlet from the heat exchanger, wherein when the heat exchanger operates with the natural circulation the first and second flow valves are positioned such that refrigerant does not flow through the respective first and second flow valves.

Numbered Paragraph 79. The HVAC system for a vehicle of any one of Numbered Paragraphs 64-78, wherein the heat exchanger is disposed within a circulating coolant flow path, wherein coolant flows into the heat exchanger at an inlet at or proximate to a lower portion within the heat exchanger and coolant flows out of the heat exchanger at or proximate to a higher portion within the heat exchanger, such that coolant flowing through the heat exchanger interacts with air flowing from the second inlet before interacting with air flowing from the first inlet as coolant flows through the heat exchanger.

Numbered Paragraph 80. The HVAC system for a vehicle of Numbered Paragraph 79, further comprising a pump within the circulating coolant flow path that, during operation when the HVAC system is desired to provide heat to the air flowing from the first air inlet, the pump causes flow within the circulating flow path such that coolant enters the heat exchanger at the inlet and leaves the heat exchanger though the outlet.

Numbered Paragraph 81. The HVAC system of any one of Numbered Paragraphs 78-80, further comprising a bypass line that connects to the coolant flow with a first connection proximate to the inlet of the heat exchanger and a second connection proximate to the outlet of the heat exchanger, and a pump within the bypass line that urges flow from the outlet of the heat exchanger to the inlet of the heat exchanger, and further comprising a fourth isolation upstream of a connection between the bypass line and the inlet and a fifth isolation valve downstream of a connection between the bypass line and the outlet, wherein the fourth and fifth isolation valves are shut and the pump operates when the first and second valves are open.

Numbered Paragraph 82. The HVAC system of any one of Numbered Paragraphs 64-81, wherein the first air inlet also is configured to receive air that flows from the passenger compartment of the vehicle, wherein further comprising a valve within the first air inlet that provides for air flow from outside the vehicle, or from inside the passenger compartment, or a portion of air from outside the vehicle and a portion of air from the passenger compartment.

1. A HVAC system for a vehicle, comprising:
a first air inlet configured, when installed within a vehicle, to receive air that flows therein from outside of the vehicle;
a second air inlet different from the first air inlet, the second air inlet configured, when installed within the vehicle, to receive air that flows therein from within a passenger compartment of the vehicle;
a heat exchanger disposed to receive air from the first air inlet and the second air inlet via different flow paths simultaneously,
further comprising a first air outlet configured to receive air from the heat exchanger that flowed into the heat exchanger from the second air inlet, the first air outlet is aligned to cause air that flows into the first air outlet to flow outside of the vehicle, the air leaves the first air outlet at an end portion,
a second air flow path with an air inlet and an air outlet, the second air flow path is positioned upon the vehicle such that outside air flows into the air inlet and out of the air outlet when the vehicle moves in a forward direction, wherein the air inlet is connected to a first portion at a constant first cross-sectional area, the first portion is connected to a second portion with a cross-sectional area that decreases below the first cross-sectional area along its length, the second portion is connected to a third portion with a cross-sectional area that increases for at least a portion of its length,
wherein the first air outlet is connected to the second air flow path, such that air from the first air outlet flows into the second air flow path.

2. The HVAC system for a vehicle of claim 1, wherein the air from the first outlet enters into the second air flow path in the second portion.

3. The HVAC system for a vehicle of claim 1, wherein the air from the first outlet enters into the second air flow path in the third portion.

4. The HVAC system for a vehicle of claim 3, wherein the air from the first outlet enters into the second air flow path in the third portion just past an interface between the second portion and the third portion.

5. The HVAC system for a vehicle of claim 2, further comprising a valve within the first air outlet that is movable from a first position that allows air from the heat exchanger and through the first air outlet to the end portion of the first air outlet, and a second position that prevents air from flowing from the heat exchanger and through the first air outlet to reach the end portion of the first air outlet.

6. The HVAC system for a vehicle of claim 5, wherein the valve is a barrel valve, wherein the barrel valve comprises an inlet aperture, and outlet aperture, and blocking portion establishes a flow path between the inlet and outlet apertures, the blocking portion prevents air flow into the flow path other than from the inlet and outlet apertures,
wherein when the barrel valve is in the second position, the blocking portion blocks air flow from the first air inlet from flowing through the first outlet portion to the first air outlet.

7. The HVAC system for a vehicle of claim 6, wherein the blocking portion is withdrawn from proximate to the heat exchanger when the barrel valve is in the second position, such that the barrel valve does not block air flow from the first air inlet to the heat exchanger.

8. The HVAC system for a vehicle of claim 6, wherein the blocking portion comprises a curved circumferential portion that extends between the inlet aperture and the outlet aperture, and further comprises parallel and spaced apart first and second side panels that extend between the inlet aperture and outlet aperture.

9. The HVAC system for a vehicle of claim 1, wherein the heat exchanger is an evaporator for a heat pump system or an air conditioning system.

10. The HVAC system for a vehicle of claim 1, wherein the first air inlet is positioned to cause air flow through the heat exchanger at a first position within the heat exchanger that is vertically above a second position within the heat exchanger, wherein the second air inlet is positioned to cause air flow through the heat exchanger at the second position.

11. The HVAC system for a vehicle of claim 3, wherein the first air inlet is positioned to cause air flow through the heat exchanger in a first direction, and the second air inlet is positioned to cause air flow through the heat exchanger in a second direction that is substantially opposite to the first direction.

12. The HVAC system for a vehicle of claim 1, wherein the heat exchanger is a portion of a heat pump system, wherein when the HVAC system is operated to add heat to the air that flows through the first air inlet, the heat exchanger is an evaporator of the heat pump system, wherein the evaporator receives refrigerant therein.

13. The HVAC system for a vehicle of claim 12, wherein when the valve is in the first position, the heat pump system is configured to operate such that a compressor within the heat pump system does not operate to cause movement of the refrigerant within the evaporator,
wherein when the HVAC system is operated to add heat to the air that flows from the first air inlet past the heat exchanger, flow of air from the second inlet through the heat exchanger and toward the first outlet transfers heat from the air to the refrigerant within the heat exchanger proximate to the air flow from the second inlet to the first outlet, which causes refrigerant proximate to the air flow from the second inlet to the second outlet to travel upwardly within the heat exchanger to a position proximate to an air flow across the heat exchanger from the first air inlet such that the refrigerant proximate the first inlet thermally interacts with air traveling past the heat exchanger from the first air inlet.

14. The HVAC system of claim 12, wherein the heat pump system comprises first and second flow valves disposed within respective inlet and outlet refrigerant lines outside of the heat exchanger that allow flow of a refrigerant through the heat exchanger with the first flow valve disposed at a refrigerant inlet to the heat exchanger, and a second flow valve disposed at a refrigerant outlet from the heat exchanger, wherein when the heat exchanger operates with the natural circulation the first and second flow valves are positioned such that refrigerant does not flow through the respective first and second flow valves.

15. The HVAC system for a vehicle of claim 1, wherein the heat exchanger is disposed within a circulating coolant flow path, wherein coolant flows into the heat exchanger at an inlet at or proximate to a lower portion within the heat exchanger and coolant flows out of the heat exchanger at or proximate to a higher portion within the heat exchanger, such that coolant flowing through the heat exchanger interacts with air flowing from the second inlet before interacting with air flowing from the first inlet as coolant flows through the heat exchanger.

16. The HVAC system for a vehicle of claim 15, further comprising a pump within the circulating coolant flow path that, during operation when the HVAC system is desired to provide heat to the air flowing from the first air inlet, the pump causes flow within the circulating flow path such that coolant enters the heat exchanger at the inlet and leaves the heat exchanger though the outlet.

17. The HVAC system of claim 16, further comprising a bypass line that connects to the coolant flow with a first connection proximate to the inlet of the heat exchanger and a second connection proximate to the outlet of the heat exchanger, and a pump within the bypass line that urges flow from the outlet of the heat exchanger to the inlet of the heat exchanger, and further comprising a fourth isolation upstream of a connection between the bypass line and the inlet and a fifth isolation valve downstream of a connection between the bypass line and the outlet, wherein the fourth and fifth isolation valves are shut and the pump operates when the first and second valves are open.

18. The HVAC system of claim 1, wherein the first air inlet also is configured to receive air that flows from the passenger compartment of the vehicle, wherein further comprising a valve within the first air inlet that provides for air flow from outside the vehicle, or from inside the passenger compartment, or a portion of air from outside the vehicle and a portion of air from the passenger compartment.
